(19) United States
(12) Patent Application Publication
(10) Pub. No.: US 2026/0019158 A1
(43) Pub. Date: Jan. 15, 2026

(54) OPTICAL TRANSCEIVER MODULE AND OPERATING METHOD THEREOF

(71) Applicant: AuthenX Inc., Zhubei City (TW)

(72) Inventors: Yi-Ting LU, Zhubei City (TW); Hung-Shen CHEN, Zhubei City (TW); Sheng-Fu LIN, Zhubei City (TW); Po-Kuan SHEN, Zhubei City (TW); Chu-Ching TSAI, Zhubei City (TW); Jenq-Yang CHANG, Zhubei City (TW); Mao-Jen WU, Zhubei City (TW)

(73) Assignee: AuthenX Inc., Zhubei City (TW)

(21) Appl. No.: 19/250,252

(22) Filed: Jun. 26, 2025

Related U.S. Application Data
(60) Provisional application No. 63/670,695, filed on Jul. 12, 2024.

(51) Int. Cl. H04B 10/40; H04B 10/11; H04B 10/50; H04B 10/61

(52) U.S. Cl. CPC H04B 10/40; H04B 10/11; H04B 10/503; H04B 10/614

(57) ABSTRACT

An optical transceiver module includes a boss structure, an optical fiber, and a photonic integrated circuit (PIC) chip. The optical fiber has a transceiver port facing the boss structure and is configured to receive a first optical signal and output a second optical signal. The PIC chip is on a vertical surface of the boss structure, coupled to the optical fiber, and configured to output the first optical signal and receive the second optical signal. The PIC chip has a side surface opposite to the transceiver port. The PIC chip includes an edge coupler and a first photodetector. The edge coupler is adjacent to the side surface and configured to couple the first optical signal to the optical fiber and to receive the second optical signal from the optical fiber. The first photodetector is configured to receive at least part of the second optical signal.

### CROSS-REFERENCE TO RELATED APPLICATION

This application claims priority to U.S. Provisional Application Ser. No. 63/670,695, filed Jul. 12, 2024, which is herein incorporated by reference in its entirety.

### BACKGROUND

### Field of Disclosure

The present disclosure relates to an optical transceiver module and an operating method thereof.

### Description of Related Art

As process technology advances, requirements for data transmission and calculation rates increase. Therefore, the semiconductor industry is facing the challenge of integrating more complex circuits into a unit area. However, the data transmission bandwidth of traditional electronic integrated circuits (EIC) is limited. As a result, how to integrate optical components into electronic integrated circuits has become a critical issue to be solved by those in the industry, to convert electrical signals into optical signals for data transmission to increase data transmission bandwidth.

### SUMMARY

An aspect of the disclosure is to provide an optical transceiver module and an operating method of an optical transceiver module that may efficiently solve the aforementioned problems.

According to an embodiment of the disclosure, an optical transceiver module includes a boss structure, an optical fiber, and a photonic integrated circuit chip. The boss structure has a vertical surface. The optical fiber has a transceiver port facing the boss structure and is configured to receive a first optical signal and output a second optical signal. The first optical signal has a first wavelength. The second optical signal has a second wavelength that is different from the first wavelength. The photonic integrated circuit chip is on the vertical surface of the boss structure, coupled to the optical fiber, and configured to output the first optical signal and receive the second optical signal. The photonic integrated circuit chip has a side surface opposite to the transceiver port of the optical fiber. The photonic integrated circuit chip includes a laser emitter, an edge coupler, and a first photodetector. The laser emitter is configured to generate the first optical signal. The edge coupler is adjacent to the side surface, configured to couple the first optical signal to the optical fiber, and configured to receive the second optical signal from the optical fiber. The first photodetector is configured to receive at least part of the second optical signal.

According to another embodiment of the disclosure, an operating method of an optical transceiver module includes generating a first optical signal through a first laser emitter. The first optical signal has a first wavelength. The operating method further includes transmitting the first optical signal to an edge coupler through a wavelength division multiplexer. The operating method further includes coupling the first optical signal to an optical fiber and receiving a second optical signal from the optical fiber through the edge coupler. The second optical signal has a second wavelength that is different from the first wavelength. The operating method further includes splitting the second optical signal into a first portion of light and a second portion of light through a polarization beam rotator splitter. The first portion of light has a first mode. The second portion of light has a second mode. The first mode is one of a transverse electric mode and a transverse magnetic mode, and the second mode is the other one of the transverse electric mode and the transverse magnetic mode. The operating method further includes modulating the second portion of light through the polarization beam rotator splitter such that the modulated second portion of light has the first mode. The operating method further includes receiving at least part of the first portion of light through a first photodetector.

Accordingly, in the optical transceiver module and the operating method of the optical transceiver module of the present disclosure, in the optical transceiver module and its operating method of some embodiments of the present disclosure, by integrating the functions of signal output and reception into the photonic integrated circuit chip, and providing the photonic integrated circuit chip with a single transceiver port coupled to a single optical fiber, the loss of optical signals during coupling can be reduced while achieving bidirectional signal transmission, thereby improving system efficiency and performance. In addition, by disposing an edge coupler as the transceiver port of the photonic integrated circuit chip and orienting the side face of the photonic integrated circuit chip adjacent to the edge coupler toward the optical fiber for light reception, the number of optical fiber connection points can be reduced. Thus, mechanical instability and alignment errors can be reduced. Meanwhile, the photonic integrated circuit chips of some embodiments of the present disclosure can be applied to a TO-CAN type packaging structure, which simplifies the packaging process, reduces costs, and improves production efficiency.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is an exploded view of an optical transceiver module according to some embodiments of the present disclosure;

FIG. 2 is a cross-sectional view of an optical transceiver module according to some embodiments of the present disclosure;

FIG. 3 is a schematic diagram of signal transmission of an optical transceiver module according to some embodiments of the present disclosure;

FIG. 4A is a perspective view of an optical fiber and a photonic integrated circuit chip of an optical transceiver module according to some embodiments of the present disclosure;

FIG. 4B is a top view of a wavelength division multiplexer of a photonic integrated circuit chip of an optical transceiver module according to some embodiments of the present disclosure; and

FIG. 5, FIG. 6, and FIG. 7 are schematic diagrams of signal transmission of an optical transceiver module according to some other embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

In the drawings, thicknesses of layers, films, panels, regions, etc., are exaggerated for clarity. It should be understood that when an element such as a layer, a film, a region, or a substrate is described as being “on” or “connected to” another element, it can be directly on or connected to the other element, or intermediate elements may also be present. In contrast, when an element is described as being “directly on” or “directly connected to” another element, there are no intermediate elements present. As used herein, “connected” may refer to physical and/or electrical connections. Furthermore, “electrically connected” or “coupled” can indicate the presence of other elements between the two elements.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terms used herein are merely for the purpose of describing specific embodiments and are not intended to be limiting. As used herein, the singular forms “a,” “an,” and “the” are intended to include the plural forms, including “at least one,” unless the context clearly indicates otherwise. “Or” indicates “and/or.” As used herein, the term “and/or” includes any and all combinations of one or more of the associated listed items. It should also be understood that when used in the specification, the terms “comprising” and/or “including” specify the presence of said features, regions, entities, steps, operations, elements and/or components, but do not exclude the presence or addition of one or more other features, regions, entities, steps, operations, elements, components, and/or combinations thereof.

A relatively acceptable deviation range or standard deviation may be chosen for the terms “about,” “approximately,” “substantially,” and the like as used herein based on optical properties, etching properties, or other properties, rather than a single standard deviation applied to all properties.

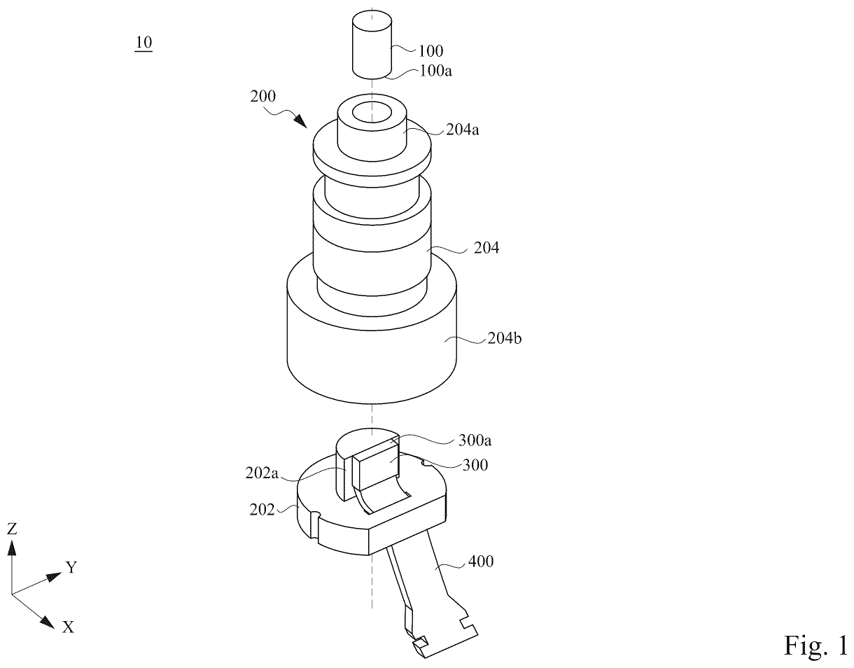

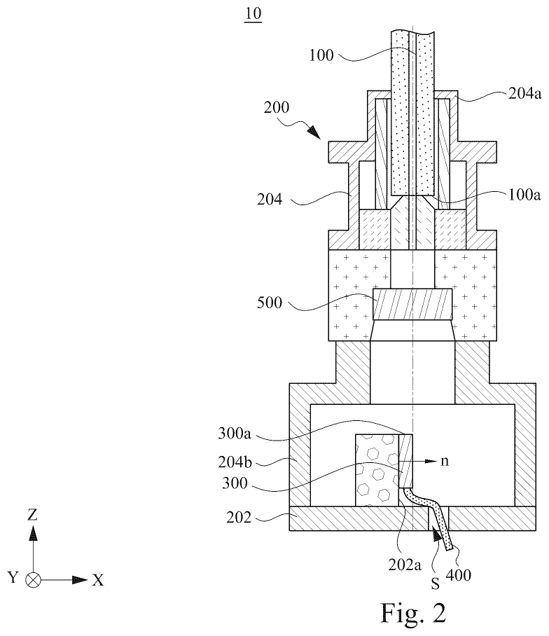

Reference is made to FIG. 1 and FIG. 2, which are an exploded view and a cross-sectional view of an optical transceiver module 10 according to some embodiments of the present disclosure, respectively. A direction X, a direction Y, and a direction Z are as shown.

The optical transceiver module 10 includes an optical fiber 100, a packaging structure 200, a photonic integrated circuit chip 300 (PIC chip), and a flexible printed circuit board 400 (FPCB).

The optical fiber 100 has a transceiver port 100a configured for receiving and outputting optical signals.

The packaging structure 200 includes a boss structure 202 and a housing 204. The boss structure 202 has a platform and a protrusion on the platform. The protrusion has a vertical surface 202a. In some embodiments, as shown in FIG. 2, a vector of a central axis of the optical fiber 100 is along a direction of the dashed line, and a normal vector n of the vertical surface 202a is along a direction of the arrow and is substantially perpendicular to the vector of the central axis of the optical fiber 100. In some embodiments, the boss structure 202 is a transistor outline header (TO header) of a transistor outline can type package (TO-CAN package). However, the present disclosure is not limited thereto.

The photonic integrated circuit chip 300 is coupled to the optical fiber 100 and configured to output an optical signal (e.g., the optical signal Tx below) to the optical fiber 100 or receive an optical signal (e.g., the optical signal Rx below) from the optical fiber 100. The photonic integrated circuit chip 300 is on the vertical surface 202a. In greater detail, a bottom surface of the photonic integrated circuit chip 300 is connected to the vertical surface 202a. As such, the photonic integrated circuit chip 300 has a side surface 300a on a side that is away from the platform of the boss structure 202.

The flexible printed circuit board 400 is connected to the photonic integrated circuit chip 300 and configured to drive photonic integrated circuit chip 300. Although FIG. 1 and FIG. 2 show that the flexible printed circuit board 400 is connected to one side of the photonic integrated circuit chip 300, in practical applications, one skilled in the art may perform wire bonding on multiple sides of the photonic integrated circuit chip 300 as needed. In some embodiments, as shown in FIG. 2, the platform of the boss structure 202 has a slit S penetrating through the platform, and the flexible printed circuit board 400 extends to the outside of the packaging structure 200 through the slit S.

The housing 204 has a first end 204a and a second end 204b. The transceiver port 100a of the optical fiber 100 extends into the housing 204 through an opening of the first end 204a. The boss structure 202 extends into the housing 204 and is engaged in the housing 204 through an opening of the second end 204b.

The cross-sectional view of the components of the optical transceiver module 10 after assembly is shown in FIG. 2. The transceiver port 100a of the optical fiber 100 is facing the boss structure 202. In greater detail, the transceiver port 100a of the optical fiber 100 is opposite to the side surface 300a of the photonic integrated circuit chip 300.

In some embodiments, as shown in FIG. 2, the optical transceiver module 10 further includes a lens 500. The lens 500 is coupled between the optical fiber 100 and the photonic integrated circuit chip 300 to utilize the light-gathering property of the lens to reduce the loss of optical signals and increase the optical coupling efficiency.

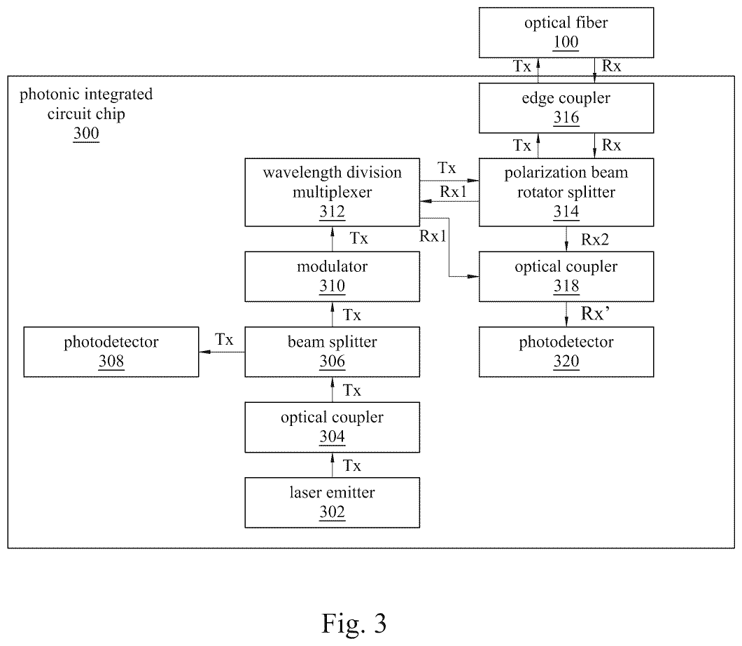

FIG. 3 is a schematic diagram of signal transmission of the optical transceiver module 10 according to some embodiments of the present disclosure. The signal transmission relationship among the components included in the photonic integrated circuit chip 300 and the optical fiber 100 are described with reference to FIG. 3. Also, an operating method of the optical transceiver module 10 is described.

As shown in FIG. 3, the optical fiber 100 is configured to receive a first optical signal (hereinafter referred to as the optical signal Tx) and output a second optical signal (hereinafter referred to as the optical signal Rx). To achieve multiplexed transmission of optical signals with different wavelengths, the optical signal Tx has first wavelength, the optical signal Rx has a second wavelength, and the second wavelength is different from the first wavelength.

As shown in FIG. 3, the photonic integrated circuit chip 300 is configured to generate the optical signal Tx, output the optical signal Tx to the optical fiber 100, receive the optical signal Rx from the optical fiber 100, and detect the optical signal Rx.

To be more specific, the photonic integrated circuit chip 300 includes a laser emitter 302, an edge coupler 316, and a photodetector 320 thereon.

The laser emitter 302 is electrically connected to the flexible printed circuit board 400 and configured to convert an electrical signal provided by the flexible printed circuit board 400 into the optical signal Tx. In some embodiments, the laser emitter 302 may be an edge emitting laser diode or a surface emitting laser diode. However, the present disclosure is not limited thereto.

The edge coupler 316 is coupled to the optical fiber 100, configured to couple the optical signal Tx from the laser emitter 302 to the optical fiber 100, and configured to receive the optical signal Rx from the optical fiber 100.

The photodetector 320 is electrically connected to the flexible printed circuit board 400 and configured to receive and detect at least part of the optical signal Rx and convert the at least part of the optical signal Rx to an electrical signal. In some embodiments, the photodetector 320 may be a p-i-n photodiode or an avalanche photodiode (APD). However, the present disclosure is not limited thereto.

First, the transmission path of the optical signal Tx in the photonic integrated circuit chip 300 and the related operating method are described. It should be noted that, in some embodiments, the optical signal Tx is single-polarized light. For example, the optical signal Tx has a transverse electric mode (TE mode).

In some embodiments, as shown in FIG. 3, the photonic integrated circuit chip 300 further includes a wavelength division multiplexer 312 (WDM) and a polarization beam rotator splitter 314 (PBRS) thereon for transmitting the optical signal Tx. In some embodiments, the wavelength division multiplexer 312 may be a directional coupler, a Y-junction coupler, a multi-mode interference coupler, or a Mach-Zehnder interferometer coupler, but the present disclosure is not limited thereto. In some embodiments, the polarization beam rotator splitter 314 may be in the form of a directional coupler or a multi-mode interference coupler, but the present disclosure is not limited thereto.

In the operating method of the optical transceiver module 10, the optical signal Tx is generated through the laser emitter 302. Then, the optical signal Tx from the laser emitter 302 is transmitted to the edge coupler 316 through the wavelength division multiplexer 312. Next, the optical signal Tx is coupled to the optical fiber 100 through the edge coupler 316.

In some embodiments, the polarization beam rotator splitter 314 is connected to the wavelength division multiplexer 312 and the edge coupler 316. In such embodiments, the optical signal Tx is received from the wavelength division multiplexer 312 and transmitted to the edge coupler 316 through the polarization beam rotator splitter 314. In other words, the optical signal Tx is transmitted to the polarization beam rotator splitter 314 through the wavelength division multiplexer 312 and in turn transmitted to the edge coupler 316.

In some embodiments, as shown in FIG. 3, the photonic integrated circuit chip 300 further includes an optical coupler 304, a beam splitter 306, a photodetector 308, and a modulator 310 for facilitating transmission of the optical signal Tx. The photodetector 308 is electrically connected to the flexible printed circuit board 400.

To be more specific, the optical coupler 304 is connected to the laser emitter 302 and configured to receive the optical signal Tx generated through the laser emitter 302 and increase incident light quantity. In some embodiments, the optical coupler 304 may be an edge coupler or a grating coupler. However, the present disclosure is not limited thereto.

The beam splitter 306 is connected to the optical coupler 304, the photodetector 308, and the modulator 310. The optical coupler 304 transmits the optical signal Tx to the beam splitter 306, and the beam splitter 306 splits the optical signal Tx into two portions of light. One portion (e.g., 1% of the optical signal Tx) is transmitted to the photodetector 308 to monitor whether the laser emitter 302 functions as required. Meanwhile, the other portion (e.g., the other 99% of the optical signal Tx) is transmitted to the modulator 310 to modulate the phase of the optical signal Tx for subsequent transmission. In some embodiments, the photodetector 308 is a monitor photodiode (MPD). In some embodiments, the modulator 310 is a Mach-Zehnder modulator, a micro-ring modulator, or an electro-absorption modulator. However, the present disclosure is not limited thereto.

The modulator 310 is connected to the wavelength division multiplexer 312. The optical signal Tx that is modulated through the modulator 310 is transmitted through the wavelength division multiplexer 312, the polarization beam rotator splitter 314 to the edge coupler 316, and then to the optical fiber 100 through the edge coupler 316, as aforementioned.

Then, the transmission path of the optical signal Rx in the photonic integrated circuit chip 300 and the related operating method are described. It should be noted that, in some embodiments, the optical signal Rx is dual-polarized light. For example, the optical signal Rx has a transverse electromagnetic mode (TEM mode). In some embodiments, the optical signal Rx may be modulated according to the optical mode applicable to the photodetector 320 so as to have a suitable optical mode or be converted into single polarized light. For example, the optical signal Rx is modulated to have the transverse electric mode, which is the same mode as that of the optical signal Tx.

In the operating method of the optical transceiver module 10, the optical signal Rx is received from the optical fiber 100 through the edge coupler 316. Then, the polarization beam rotator splitter 314 receives the optical signal Rx from the edge coupler 316 and splits the optical signal Rx into a first portion of light and a second portion of light. The first portion of light has a first mode. The second portion of light has a second mode. The first mode is one of a transverse electric mode and a transverse magnetic mode (TM mode). The second mode is the other one of the transverse electric mode and the transverse magnetic mode. For example, the first mode is a transverse electric mode, and the second mode is a transverse magnetic mode. Then, the first portion of light acts as the optical signal Rx1, and the second portion of light is modulated through the polarization beam rotator splitter 314 such that the modulated second portion of light has the first mode (e.g., a transverse electric mode) and is then transmitted as the optical signal Rx2.

In some embodiments, the optical signal Rx1 is received from the polarization beam rotator splitter 314 and transmitted to the photodetector 320 through the wavelength division multiplexer 312. In such embodiments, the polarization beam rotator splitter 314 is connected to the wavelength division multiplexer 312 and the edge coupler 316, and the wavelength division multiplexer 312 is not directly connected to the edge coupler 316.

In some embodiments, the photonic integrated circuit chip 300 further includes an optical coupler 318. The wavelength division multiplexer 312 and the polarization beam rotator splitter 314 are respectively connected to the optical coupler 318. The optical signal Rx1 and the optical signal Rx2 are transmitted to the optical coupler 318 and combined into an optical signal Rx′ having the first mode (e.g., a transverse electric mode). Then, the photodetector 320 receives and detects the optical signal Rx′ and converts the optical signal Rx′ into an electrical signal. In some embodiments, the optical coupler 318 may be an edge coupler or a grating coupler. However, the present disclosure is not limited thereto.

As such, bidirectional signal transmission between the optical fiber 100 and the photonic integrated circuit chip 300 can be achieved through the optical transceiver module 10 of some embodiments of the present disclosure. In such embodiments, the optical fiber 100 and the photonic integrated circuit chip 300 receive and output signals through one-to-one transceiver ports (e.g., the transceiver port 100a of the optical fiber 100 and the edge coupler 316 of the photonic integrated circuit chip 300). This reduces the number of optical fiber connection points and reduces mechanical instability and alignment errors. Meanwhile, the loss of the optical signal during the coupling process may be reduced, thereby improving the efficiency and performance of the system. Therefore, the optical transceiver module 10 of some embodiments of the present disclosure is suitable for application in miniaturized high-density photonic integrated circuits. In addition, since the functions of signal reception and output are integrated onto the photonic integrated circuit chip 300, the aforementioned TO-CAN packaging structure may be applied to simplify the packaging process, reduce costs, and improve production efficiency.

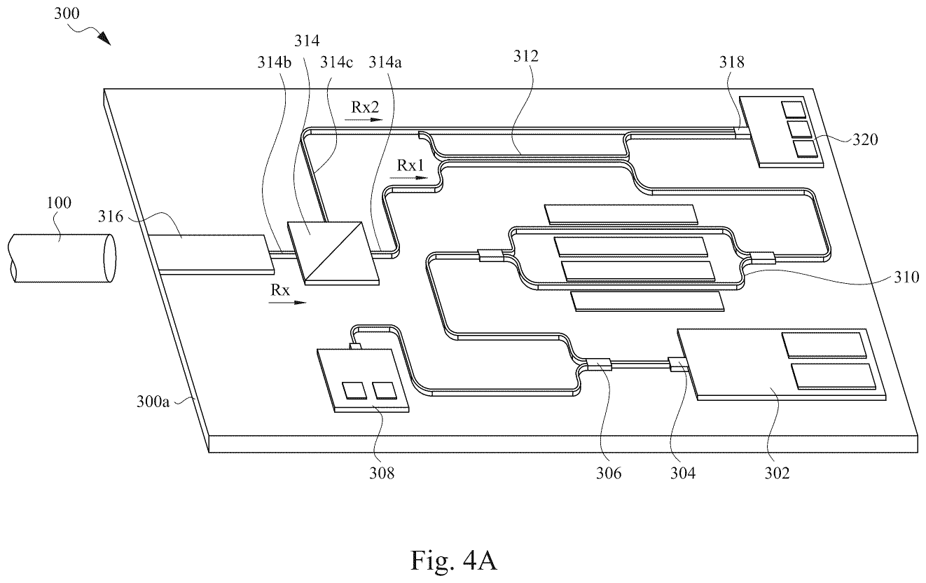

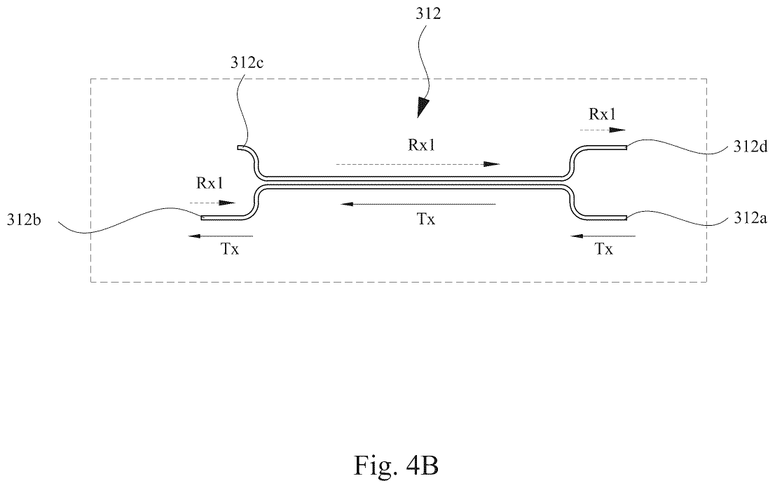

Reference is made to FIG. 4A and FIG. 4B. FIG. 4A is a perspective view of the optical fiber 100 and the photonic integrated circuit chip 300 according to some embodiments of the present disclosure. FIG. 4B is a top view of the wavelength division multiplexer 312 of the photonic integrated circuit chip 300 according to some embodiments of the present disclosure.

The configuration of the optical fiber 100 and the photonic integrated circuit chip 300 are shown in FIG. 4A. The optical fiber 100 faces the side surface 300a of the photonic integrated circuit chip 300. It should be noted that there may be some other components disposed between the optical fiber 100 and the photonic integrated circuit chip 300 such as a fiber stub, a lens, etc., which are not illustrated in FIG. 4A. The present disclosure is not limited thereto.

The components of the photonic integrated circuit chip 300 are configured as shown in FIG. 4A. It should be noted that the edge coupler 316 of the photonic integrated circuit chip 300 is adjacent to the side surface 300a and is coupled to the optical fiber 100 to act as the transceiver port of the photonic integrated circuit chip 300. The positions of other components may be modified according to practical needs without departing from the scope of the present disclosure.

In some embodiments, the components of the photonic integrated circuit chip 300 including the laser emitter 302, the photodetector 308, and the photodetector 320 may be formed on, for example, a silicon substrate through epitaxial growth. In other words, the laser emitter 302 may be an embedded laser emitter and the photodetector 308 and the photodetector 320 may be embedded photodetectors integrated on the photonic integrated circuit chip 300. In some other embodiments, the laser emitter 302, the photodetector 308, and the photodetector 320 may be flip-chip mounted after other components are formed on the substrate.

Moreover, both the optical coupler 304 and the optical coupler 318 illustrated in FIG. 4A are edge couplers. In some other embodiments, the optical coupler 304 and/or the optical coupler 318 may be grating couplers disposed below the laser emitter 302 and the photodetector 320, respectively.

As shown in FIG. 4A, the polarization beam rotator splitter 314 has a port 314a, a port 314b, and a port 314c, which are configured to transmit different optical signals, respectively. To be more specific, the port 314a is connected to the wavelength division multiplexer 312, configured to receive the optical signal Tx from the wavelength division multiplexer 312, and configured to transmit the optical signal Rx1 that is split from the optical signal Rx from the polarization beam rotator splitter 314 to the wavelength division multiplexer 312. The port 314b is connected to the edge coupler 316, configured to transmit the optical signal Tx to the edge coupler 316, and configured to receive the optical signal Rx from the edge coupler 316. The port 314c is connected to the optical coupler 318 and configured to transmit the optical signal Rx2 that is split from the optical signal Rx and modulated to have the first mode through the polarization beam rotator splitter 314 to the optical coupler 318.

On the other hand, as shown in FIG. 4B, the wavelength division multiplexer 312 has a first portion and a second portion that are separated from each other. A middle section of the first portion is adjacent to and substantially parallel to a middle section of the second portion. The first portion has a port 312a and a port 312b at two opposite ends of its middle section. The second portion has a port 312c and a port 312d at two opposite ends of its middle section. The port 312a is adjacent to the port 312d. The port 312b is adjacent to the port 312c. As shown in FIG. 4A and FIG. 4B, the port 312a is connected to the modulator 310. The port 312b is connected to a port 314a of the polarization beam rotator splitter 314. The port 312c is an unconnected, idle port. In other words, the port 312c is not connected to any component. The port 312d is connected to the optical coupler 318. The optical signal Tx is transmitted from the modulator 310 through the port 312a, the middle section of the first portion, and the port 312b to the polarization beam rotator splitter 314. At the same time, by utilizing the wavelength selectivity of the coupling of evanescent wave, the optical signal Rx1 is transmitted from the polarization beam rotator splitter 314 and through the port 312b, coupled to the middle section of the second portion, and then transmitted to the optical coupler 318 through the port 312d. The bidirectional wavelength division multiplexer 312 helps realize the single transceiver port feature of the photonic integrated circuit chip 300.

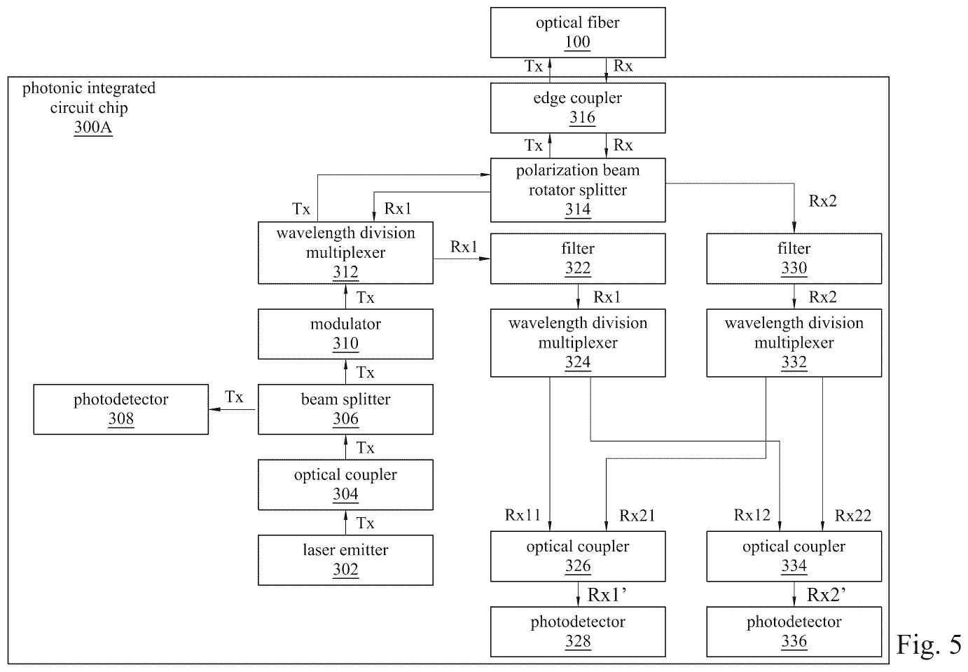

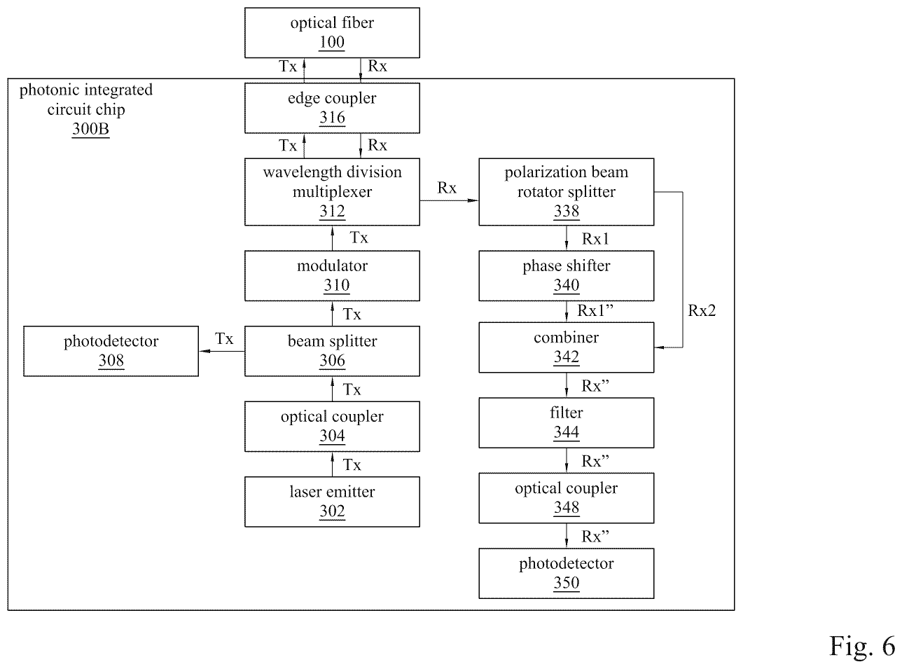

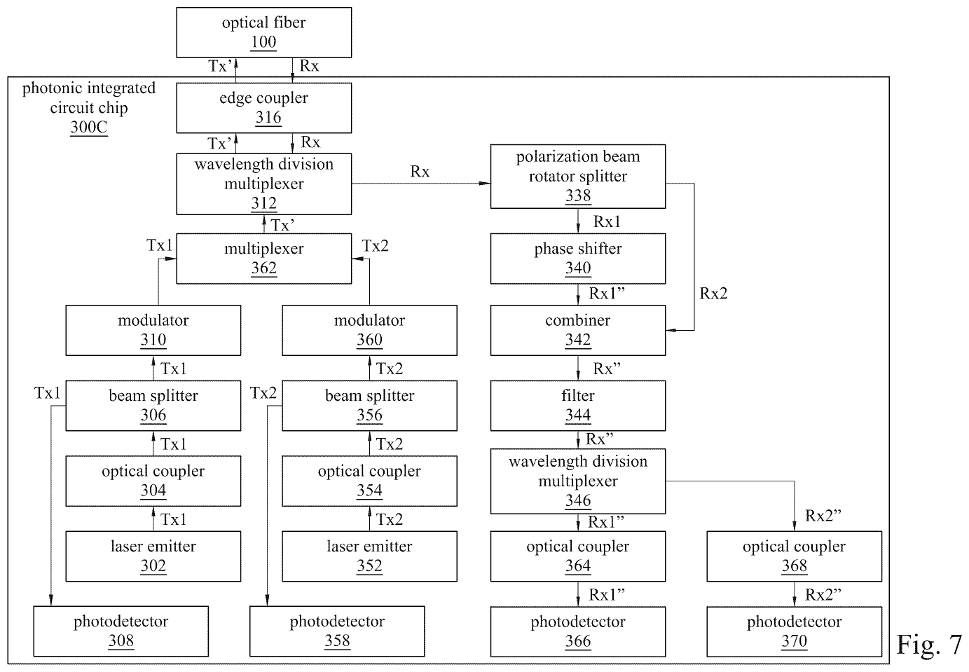

FIG. 5 is a schematic diagram of signal transmission of the optical transceiver module 10 according to some other embodiments of the present disclosure. In the embodiments corresponding to FIG. 5, the optical transceiver module 10 includes a photonic integrated circuit chip 300A.

Similar to the photonic integrated circuit chip 300, the photonic integrated circuit chip 300A includes a laser emitter 302, an optical coupler 304, a beam splitter 306, a photodetector 308, a modulator 310, a wavelength division multiplexer 312, a polarization beam rotator splitter 314, and an edge coupler 316. As a result, in the photonic integrated circuit chip 300A, the path of the optical signal Tx transmitted from the laser emitter 302 to the optical fiber 100 is substantially the same as that of the photonic integrated circuit chip 300.

One of the differences between the photonic integrated circuit chip 300A and the photonic integrated circuit chip 300 is that the photonic integrated circuit chip 300A includes two photodetectors. Meanwhile, the photonic integrated circuit chip 300A is configured to split the optical signal Rx into two portions of light with different wavelengths and respectively transmit the two portions of light to the two photodetectors.

For example, a central wavelength of the optical signal Rx (hereinafter the second wavelength) is about 1350 nm, and the photonic integrated circuit chip 300A is configured to split the optical signal Rx into two portions of light with central wavelengths of about 1342 nm and about 1358 nm, respectively. In addition, a central wavelength of the optical signal Tx (hereinafter the first wavelength) may be about 1300 nm. In such embodiments, the optical signal Tx and the optical signal Rx transmitted through the photonic integrated circuit chip 300A both belong to the original band (O band). However, the present disclosure is not limited thereto.

To achieve the aforementioned objectives, the photonic integrated circuit chip 300A includes a filter 322, a wavelength division multiplexer 324, an optical coupler 326, a photodetector 328, a filter 330, a wavelength division multiplexer 332, an optical coupler 334, and a photodetector 336.

The filter 322 and the filter 330 are configured to select light with specific wavelengths and filter out unnecessary noises. In some embodiments, the filter 322 and/or the filter 330 may be in the form of a micro-ring resonator, a Bragg grating, or a Mach-Zehnder interferometer filter. However, the present disclosure is not limited thereto.

The wavelength division multiplexer 324 and the wavelength division multiplexer 332 are configured to further split the filtered optical signals into two light portions according to wavelengths. In some embodiments, the wavelength division multiplexer 324 and/or the wavelength division multiplexer 332 may be a directional coupler, a Y-junction coupler, a multi-mode interference coupler, or a Mach-Zehnder interferometer coupler. However, the present disclosure is not limited thereto.

The optical coupler 326 and the optical coupler 334 are configured to combine optical signals having the same wavelength. In some embodiments, the optical coupler 326 and/or the optical coupler 334 may be a grating coupler or an edge coupler. However, the present disclosure is not limited thereto.

The photodetector 328 and the photodetector 336 are respectively configured to receive and detect optical signals with different central wavelengths and convert them into electrical signals. In some embodiments, the photodetector 328 and/or the photodetector 336 may be a p-i-n photodiode or an avalanche photodiode. However, the present disclosure is not limited thereto.

Next, the transmission path of the optical signal Rx in the photonic integrated circuit chip 300A and the related operating method are described.

In the operating method of such embodiments, the optical signal Rx is received from the optical fiber 100 through the edge coupler 316. Then, the optical signal Rx is split into an optical signal Rx1 and an optical signal Rx2 through the polarization beam rotator splitter 314. The optical signal Rx1 has a first mode. The optical signal Rx2 also has the first mode after being modulated through the polarization beam rotator splitter 314.

Next, the optical signal Rx1 is transmitted from the polarization beam rotator splitter 314, sequentially through the wavelength division multiplexer 312 and the filter 322, to the wavelength division multiplexer 324. The wavelength division multiplexer 324 splits the optical signal Rx1 into an optical signal Rx11, with a central wavelength of about 1342 nm, and an optical signal Rx12, with a central wavelength of about 1358 nm. The optical signal Rx11 is then transmitted to the optical coupler 326, and the optical signal Rx12 is transmitted to the optical coupler 334.

At the same time, the optical signal Rx2 is transmitted from the polarization beam rotator splitter 314 through the filter 330 to the wavelength division multiplexer 332. The wavelength division multiplexer 332 splits the optical signal Rx2 into an optical signal Rx21, with a central wavelength of about 1342 nm, and an optical signal Rx22, with a central wavelength of about 1358 nm. The optical signal Rx21 is then transmitted to the optical coupler 326, and the optical signal Rx22 is transmitted to the optical coupler 334.

The optical coupler 326 combines the optical signal Rx11 and the optical signal Rx21 into an optical signal Rx1′ having a central wavelength of about 1342 nm and transmits the optical signal Rx1′ to the photodetector 328. In other words, a portion of the optical signal Rx1 having a central wavelength of about 1342 nm and a portion of the optical signal Rx2 having a central wavelength of about 1342 nm are combined through the optical coupler 326 and then received and detected through the photodetector 328. Similarly, the optical coupler 334 combines the optical signal Rx12 and the optical signal Rx22 into an optical signal Rx2′ having a central wavelength of about 1358 nm and transmits the optical signal Rx2′ to the photodetector 336. In other words, a portion of the optical signal Rx1 having a central wavelength of about 1358 nm and a portion of the optical signal Rx2 having a central wavelength of about 1358 nm are combined through the optical coupler 334 and then received and detected through the photodetector 336.

As such, the photonic integrated circuit chip 300A of some embodiments of the present disclosure can achieve bidirectional signal transmission with the optical fiber 100 and can detect optical signals with different central wavelengths.

FIG. 6 is a schematic diagram of signal transmission of the optical transceiver module 10 according to some other embodiments of the present disclosure. In the embodiments corresponding to FIG. 6, the optical transceiver module 10 includes a photonic integrated circuit chip 300B.

Similar to the photonic integrated circuit chip 300, the photonic integrated circuit chip 300B includes a laser emitter 302, an optical coupler 304, a beam splitter 306, a photodetector 308, a modulator 310, a wavelength division multiplexer 312, and an edge coupler 316.

One of the differences between the photonic integrated circuit chip 300B and the photonic integrated circuit chip 300 is that, in the photonic integrated circuit chip 300B, the wavelength division multiplexer 312 is directly connected to the edge coupler 316.

Therefore, in the photonic integrated circuit chip 300B, the optical signal Tx generated through the laser emitter 302 is transmitted sequentially through the optical coupler 304, the beam splitter 306, and the modulator 310, then transmitted from the wavelength division multiplexer 312 directly to the edge coupler 316, and coupled to the optical fiber 100. In such embodiments, the first wavelength of the optical signal Tx may be about 1270 nm, which belongs to the O band, but the present disclosure is not limited thereto.

In addition, in the embodiments corresponding to FIG. 6, the photonic integrated circuit chip 300B further includes a polarization beam rotator splitter 338. It should be noted that, unlike the polarization beam rotator splitter 314 of the photonic integrated circuit chip 300, the polarization beam rotator splitter 338 of the photonic integrated circuit chip 300B is connected to the wavelength division multiplexer 312 and is not directly connected to the edge coupler 316. As a result, in the photonic integrated circuit chip 300B, the wavelength division multiplexer 312 receives the optical signal Rx from the edge coupler 316, and then the polarization beam rotator splitter 338 receives the optical signal Rx from the wavelength division multiplexer 312. In such embodiments, the second wavelength of the optical signal Rx may be about 1577 nm, which belongs to the long band (L band), but the present disclosure is not limited thereto.

In the operation methods of such embodiments, the optical signal Rx is split into a first portion of light having a first mode and a second portion of light having a second mode through the polarization beam rotator splitter 338. The first mode is one of a transverse electric mode and a transverse magnetic mode. The second mode is the other one of the transverse electric mode and the transverse magnetic mode. For example, the first mode is a transverse electric mode, and the second mode is a transverse magnetic mode. Then, the first portion of light acts as the optical signal Rx1, and the second portion of light is modulated through the polarization beam rotator splitter 338 such that the modulated second portion of light has the first mode (e.g., a transverse electric mode) and is then transmitted as the optical signal Rx2.

Since the polarization condition of the modulated optical signal Rx2 changes after passing through the polarization beam rotator splitter 338, there may be a phase difference between the modulated optical signal Rx2 and the unmodulated optical signal Rx1. Therefore, the phase of one of the optical signal Rx1 and the optical signal Rx2 may be adjusted to facilitate combination.

To be more specific, as shown in FIG. 6, the photonic integrated circuit chip 300B further includes a phase shifter 340 and a combiner 342. The optical signal Rx1 is transmitted from the polarization beam rotator splitter 338 to the phase shifter 340 to adjust the phase to form the optical signal Rx1″. Then, the optical signal Rx1″ is transmitted to the combiner 342. On the other hand, the optical signal Rx2 is directly transmitted to the combiner 342. Through the combiner 342, the phase-shifted optical signal Rx1″ and the optical signal Rx2 are combined into the optical signal Rx″. In some other embodiments, the optical signal Rx2 may be phase-shifted through the phase shifter 340 and then combined with the optical signal Rx1 without phase shift. In some embodiments, the phase shifter 340 may be a delay line or in the form of a thermo-optic phase shifter, a carrier injection phase shifter, a carrier depletion phase shifter, an electro-optic phase shifter, or an opto-mechanical phase shifter. However, the present disclosure is not limited thereto. In some embodiments, the combiner 342 may be in the form of a Y-junction coupler, a multi-mode interference coupler, or a directional coupler, but the present disclosure is not limited thereto.

In addition, as shown in FIG. 6, the photonic integrated circuit chip 300B further includes a filter 344, an optical coupler 348, and a photodetector 350. The optical signal Rx″ is transmitted sequentially through the filter 344 and the optical coupler 348 and is received and converted to an electrical signal through the photodetector 350. In some embodiments, the filter 344 may be in the form of a micro-ring resonator, a Bragg grating, or a Mach-Zehnder interferometer filter. The optical coupler 348 may be a grating coupler or an edge coupler. The photodetector 350 may be a p-i-n photodiode or an avalanche photodiode. However, the present disclosure is not limited thereto.

FIG. 7 is a schematic diagram of signal transmission of the optical transceiver module 10 according to some other embodiments of the present disclosure. In the embodiments corresponding to FIG. 7, the optical transceiver module 10 includes a photonic integrated circuit chip 300C.

As shown in FIG. 7, the photonic integrated circuit chip 300C includes two laser emitters and two photodetectors. To be more specific, the photonic integrated circuit chip 300C includes a laser emitter 302, a laser emitter 352, an edge coupler 316, a photodetector 366, and a photodetector 370.

The laser emitter 302 is electrically connected to the flexible printed circuit board 400 and configured to convert an electrical signal provided by the flexible printed circuit board 400 into an optical signal Tx1 having a first wavelength (e.g., about 1310 nm). The laser emitter 352 is electrically connected to the flexible printed circuit board 400 and configured to convert an electrical signal provided by the flexible printed circuit board 400 into an optical signal Tx2 (also referred to as a third optical signal) having a third wavelength (e.g., about 1330 nm). The third wavelength is different from the first wavelength. In such embodiments, both the optical signal Tx1 and the optical signal Tx2 belong to the O band. However, the present disclosure is not limited thereto. In some embodiments, the laser emitter 302 and/or the laser emitter 352 may be an edge emitting laser diode or a surface emitting laser diode. However, the present disclosure is not limited thereto.

The edge coupler 316 is coupled to the optical fiber 100, configured to couple the optical signal Tx′ combined through the optical signal Tx1 and the optical signal Tx2 to the optical fiber 100, and configured to receive the optical signal Rx from the optical fiber 100. The optical signal Rx has a second wavelength that is different from the first wavelength and the third wavelength. For example, a central wavelength of the optical signal Rx may be about 1490 nm, which belongs to the short band (S band). However, the present disclosure is not limited thereto.

The photodetector 366 and the photodetector 370 are electrically connected to the flexible printed circuit board 400 and configured to receive and detect at least part of the optical signal Rx and convert the at least part of the optical signal Rx into an electrical signal. In some embodiments, the photodetector 366 and/or the photodetector 370 may be a p-i-n photodiode or an avalanche photodiode. However, the present disclosure is not limited thereto.

The photonic integrated circuit chip 300C further includes a multiplexer 362 and a wavelength division multiplexer 312 for transmitting the optical signal Tx′. The wavelength division multiplexer 312 is connected to the multiplexer 362 and is directly connected to the edge coupler 316.

In the operating method of such embodiments, the optical signal Tx1 is generated through the laser emitter 302, and the optical signal Tx2 (also referred to as the third optical signal) is generated through the laser emitter 352. Next, the optical signal Tx1 and the optical signal Tx2 that have different wavelengths are combined into an optical signal Tx′ through the multiplexer 362 and transmitted to the wavelength division multiplexer 312. Then, the optical signal Tx′ is transmitted to the edge coupler 316 through the wavelength division multiplexer 312. Then, the optical signal Tx′ is coupled to the optical fiber 100 through the edge coupler 316.

In some embodiments, as shown in FIG. 7, the photonic integrated circuit chip 300C further includes an optical coupler 304, a beam splitter 306, a photodetector 308, a modulator 310, an optical coupler 354, a beam splitter 356, a photodetector 358, and a modulator 360 for assisting in transmitting the optical signal Tx.

To be more specific, the optical coupler 304 is connected to the laser emitter 302 and configured to receive the optical signal Tx1 generated through the laser emitter 302. The optical coupler 354 is connected to the laser emitter 352 and configured to receive the optical signal Tx2 generated through the laser emitter 352. In some embodiments, the optical coupler 304 and/or the optical coupler 354 may be an edge coupler or a grating coupler. However, the present disclosure is not limited thereto.

The beam splitter 306 is connected to the optical coupler 304, the photodetector 308, and the modulator 310. The optical coupler 304 transmits the optical signal Tx1 to the beam splitter 306. The beam splitter 306 splits the optical signal Tx1 into two portions of light. One portion (e.g., 1% of the optical signal Tx1) is transmitted to the photodetector 308 to monitor whether the laser emitter 302 functions as required. Meanwhile, the other portion (e.g., the other 99% of the optical signal Tx1) is transmitted to the modulator 310 for modulation.

Similarly, the beam splitter 356 is connected to the optical coupler 354, the photodetector 358, and the modulator 360. The optical coupler 354 transmits the optical signal Tx2 to the beam splitter 356. The beam splitter 356 splits the optical signal Tx2 into two portions of light. One portion (e.g., 1% of the optical signal Tx2) is transmitted to the photodetector 358 to monitor whether the laser emitter 352 functions as required. Meanwhile, the other portion (e.g., the other 99% of the optical signal Tx2) is transmitted to the modulator 360 for modulation. In some embodiments, the photodetector 358 may be a monitor photodiode. In some embodiments, the modulator 360 may be a Mach-Zehnder modulator, a micro-ring modulator, or an electro-absorption modulator. However, the present disclosure is not limited thereto.

The modulator 310 and the modulator 360 are connected to the multiplexer 362. The optical signal Tx1 modulated through the modulator 310 and the optical signal Tx2 modulated through the modulator 360 are transmitted to the multiplexer 362 and combined into the optical signal Tx′. The optical signal Tx′ is then transmitted to the optical fiber 100 through the wavelength division multiplexer 312 and the edge coupler 316. As aforementioned, in some embodiments, the multiplexer 362 may be a multi-mode interference coupler, an array waveguide grating, a Mach-Zehnder interferometer coupler, a micro-ring resonator, or a directional coupler. However, the present disclosure is not limited thereto.

The transmission path of the optical signal Rx in the photonic integrated circuit chip 300C is described below.

As shown in FIG. 7, the photonic integrated circuit chip 300C further includes a polarization beam rotator splitter 338, a phase shifter 340, a combiner 342, a filter 344, a wavelength division multiplexer 346, an optical coupler 364, a photodetector 366, an optical coupler 368, and a photodetector 370.

The polarization beam rotator splitter 338 is connected to the wavelength division multiplexer 312 and is not directly connected to the edge coupler 316. The optical signal Rx is transmitted from the edge coupler 316 through the wavelength division multiplexer 312 to the polarization beam rotator splitter 338. Then, the optical signal Rx is split into a first portion of light and a second portion of light through the polarization beam rotator splitter 338. The first portion of light has a first mode. The second portion of light has a second mode. The first mode is one of a transverse electric mode and a transverse magnetic mode. The second mode is the other one of the transverse electric mode and the transverse magnetic mode. For example, the first mode is a transverse electric mode, and the second mode is a transverse magnetic mode. Then, the first portion of light acts as the optical signal Rx1, and the second portion of light is modulated through the polarization beam rotator splitter 338 such that the modulated second portion of light has the first mode (e.g., a transverse electric mode) and is transmitted as the optical signal Rx2.

Next, the optical signal Rx1 is transmitted from the polarization beam rotator splitter 338 to the phase shifter 340 to adjust the phase to form the optical signal Rx1″ and then transmitted to the combiner 342. The optical signal Rx2 is directly transmitted to the combiner 342. Through the combiner 342, the phase-shifted optical signal Rx1″ and the optical signal Rx2 are combined into the optical signal Rx″. In some other embodiments, the optical signal Rx2 may be phase-shifted through the phase shifter 340 and then combined with the optical signal Rx1 without phase shift.

Then, as shown in FIG. 7, the optical signal Rx″ is transmitted through the filter 344 and the wavelength division multiplexer 346 and is split into the optical signal Rx1″ and the optical signal Rx2″ that have different central wavelengths. For example, a central wavelength of the optical signal Rx1″ is about 1480 nm and a central wavelength of the optical signal Rx2″ is about 1450 nm. In such embodiments, both the optical signal Rx1″ and the optical signal Rx2″ belong to the S band. However, the present disclosure is not limited thereto. In some embodiments, the wavelength division multiplexer 346 may be a multi-mode interference coupler, a directional coupler, or an array waveguide grating.

The optical signal Rx1″ is transmitted to the photodetector 366 through the optical coupler 364 and converted into an electrical signal. The optical signal Rx2″ is transmitted to the photodetector 370 through the optical coupler 368 and converted into an electrical signal. In some embodiments, the optical coupler 364 and/or the optical coupler 368 may be a grating coupler or an edge coupler.

As such, bidirectional transmission of signal reception and output can be achieved through the photonic integrated circuit chip 300 of some embodiments of the present disclosure, and the optical signals received and transmitted can cover different wavelengths.

According to the foregoing recitations of the embodiments of the disclosure, it may be seen that in the optical transceiver module and its operating method of some embodiments of the present disclosure, by integrating the functions of signal output and reception into the photonic integrated circuit chip, and providing the photonic integrated circuit chip with a single transceiver port coupled to a single optical fiber, the loss of optical signals during coupling can be reduced while achieving bidirectional signal transmission, thereby improving system efficiency and performance. In addition, by disposing an edge coupler as the transceiver port of the photonic integrated circuit chip and orienting the side face of the photonic integrated circuit chip adjacent to the edge coupler toward the optical fiber for light reception, the number of optical fiber connection points can be reduced. Thus, mechanical instability and alignment errors can be reduced. Meanwhile, the photonic integrated circuit chips of some embodiments of the present disclosure can be applied to a TO-CAN type packaging structure, which simplifies the packaging process, reduces costs, and improves production efficiency.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. An optical transceiver module, comprising:
a boss structure having a vertical surface;
an optical fiber having a transceiver port facing the boss structure and configured to receive a first optical signal and output a second optical signal, wherein the first optical signal has a first wavelength, and the second optical signal has a second wavelength different from the first wavelength; and
a photonic integrated circuit chip on the vertical surface of the boss structure, coupled to the optical fiber, and configured to output the first optical signal and receive the second optical signal, wherein the photonic integrated circuit chip has a side surface opposite to the transceiver port of the optical fiber, and the photonic integrated circuit chip comprises:
a laser emitter configured to generate the first optical signal;
an edge coupler adjacent to the side surface, configured to couple the first optical signal to the optical fiber, and configured to receive the second optical signal from the optical fiber; and
a first photodetector configured to receive at least part of the second optical signal.

2. The optical transceiver module of claim 1, wherein the photonic integrated circuit chip further comprises a polarization beam rotator splitter connected to the edge coupler, and the polarization beam rotator splitter is configured to:
receive the first optical signal and transmit the first optical signal to the edge coupler;
receive the second optical signal from the edge coupler;
split the second optical signal into a first portion of light and a second portion of light, wherein the first portion of light has a first mode, and the second portion of light has a second mode, wherein the first mode is one of a transverse electric mode and a transverse magnetic mode, and the second mode is the other one of the transverse electric mode and the transverse magnetic mode; and
modulate the second portion of light such that the modulated second portion of light has the first mode.

3. The optical transceiver module of claim 2, wherein the first optical signal has the first mode, and the first mode is the transverse electric mode.

4. The optical transceiver module of claim 2, wherein the photonic integrated circuit chip further comprises a wavelength division multiplexer connected to the polarization beam rotator splitter, and the wavelength division multiplexer is configured to:
transmit the first optical signal to the polarization beam rotator splitter; and
receive the first portion of light from the polarization beam rotator splitter.

5. The optical transceiver module of claim 4, wherein the photonic integrated circuit chip further comprises a second photodetector, wherein the first photodetector is further configured to receive at least part of the first portion of light, and the second photodetector is configured to receive at least part of the modulated second portion of light.

6. The optical transceiver module of claim 4, wherein the photonic integrated circuit chip further comprises an optical coupler connected to the polarization beam rotator splitter and the wavelength division multiplexer, wherein the optical coupler is configured to combine and transmit the first portion of light and the modulated second portion of light to the first photodetector.

7. The optical transceiver module of claim 1, wherein the photonic integrated circuit chip further comprises a wavelength division multiplexer connected to the edge coupler, and the wavelength division multiplexer is configured to:
transmit the first optical signal to the edge coupler; and
receive the second optical signal from the edge coupler.

8. The optical transceiver module of claim 7, wherein the photonic integrated circuit chip further comprises a polarization beam rotator splitter connected to the wavelength division multiplexer, and the polarization beam rotator splitter is configured to:
receive the second optical signal from the wavelength division multiplexer;
split the second optical signal into a first portion of light and a second portion of light, wherein the first portion of light has a first mode, and the second portion of light has a second mode, wherein the first mode is one of a transverse electric mode and a transverse magnetic mode, and the second mode is the other one of the transverse electric mode and the transverse magnetic mode; and
modulate the second portion of light such that the modulated second portion of light has the first mode.

9. The optical transceiver module of claim 8, wherein the first optical signal has the first mode, and the first mode is the transverse electric mode.

10. The optical transceiver module of claim 1, wherein the laser emitter is an embedded laser emitter.

11. The optical transceiver module of claim 1, wherein the first photodetector is an embedded photodetector.

12. The optical transceiver module of claim 1, further comprising a lens coupled between the optical fiber and the photonic integrated circuit chip.

13. An operating method of an optical transceiver module, comprising:
generating a first optical signal through a first laser emitter, wherein the first optical signal has a first wavelength;
transmitting the first optical signal to an edge coupler through a wavelength division multiplexer;
coupling the first optical signal to an optical fiber and receiving a second optical signal from the optical fiber through the edge coupler, wherein the second optical signal has a second wavelength different from the first wavelength;
splitting the second optical signal into a first portion of light and a second portion of light through a polarization beam rotator splitter, wherein the first portion of light has a first mode, and the second portion of light has a second mode, wherein the first mode is one of a transverse electric mode and a transverse magnetic mode, and the second mode is the other one of the transverse electric mode and the transverse magnetic mode;
modulating the second portion of light through the polarization beam rotator splitter such that the modulated second portion of light has the first mode; and
receiving at least part of the first portion of light through a first photodetector.

14. The operating method of claim 13, wherein the first laser emitter, the wavelength division multiplexer, the edge coupler, the polarization beam rotator splitter, and the first photodetector are disposed on a photonic integrated circuit chip, the photonic integrated circuit chip is disposed on a vertical surface of a boss structure and has a side surface facing a transceiver port of the optical fiber, and the edge coupler is adjacent to the side surface.

15. The operating method of claim 13, wherein the first optical signal has the first mode, and the first mode is the transverse electric mode.

16. The operating method of claim 13, further comprising receiving at least part of the modulated second portion of light through a second photodetector.

17. The operating method of claim 13, further comprising combining and transmitting the at least part of the first portion of light and at least part of the modulated second portion of light to the first photodetector through an optical coupler.

18. The operating method of claim 13, further comprising receiving the at least part of the first portion of light from the polarization beam rotator splitter and transmitting the at least part of the first portion of light to the first photodetector through the wavelength division multiplexer.

19. The operating method of claim 13, further comprising receiving the second optical signal from the edge coupler and transmitting the second optical signal to the polarization beam rotator splitter through the wavelength division multiplexer.

20. The operating method of claim 13, further comprising:
generating a third optical signal through a second laser emitter, wherein the third optical signal has a third wavelength different from the first wavelength; and
combining and transmitting the first optical signal and the third optical signal to the wavelength division multiplexer through a multiplexer such that the first optical signal and the third optical signal are coupled to the optical fiber through the wavelength division multiplexer and the edge coupler.
